(19) United States
(12) Patent Application Publication
(10) Pub. No.: US 2020/0309152 A1
(43) Pub. Date: Oct. 1, 2020

(54) Special Personal Cooling Device Called the Breezy Belt

(71) Applicant: Arthur C Sanford, Fishers, IN (US)

(72) Inventor: Arthur C Sanford, Fishers, IN (US)

(21) Appl. No.: 16/831,172

(22) Filed: Mar. 26, 2020

Related U.S. Application Data
(60) Provisional application No. 62/824,466, filed on Mar. 27, 2019.

(51) Int. Cl. F04D 29/44; F04D 25/06; F04D 29/60

(52) U.S. Cl. CPC F04D 29/441; F05B 2240/90; F04D 29/601; F04D 25/0673

(57) ABSTRACT

A Special Personal Cooling device that acts as an air distribution system for use by an individual to prevent heat stress and fatigue. It is a lightweight plenum manifold which spreads, throws, and distributes a flow of pressurized air about the upper or lower body of an individual, the flow of air itself capable of cooling the skin directly or cooling the clothing worn by the individual by providing a pressurized air stream that evaporates moisture and perspiration. The device is made of a resilient and durable materials configured as a belt system; a power system; a fan system; a means to mechanically and integrally secure the fan system, power system and belt system together; and an electrical control system for controlling the power from the battery to the motor and fan.

### CROSS-REFERENCE TO RELATED APPLICATIONS

This application claims the benefit of United States Provisional Patent Application with Ser. No. 62/824,466 filed Mar. 27, 2019, by Arthur C. Sanford entitled “Special Personal Cooling Device Called the Breezy Belt”.

### FIELD OF INVENTION

This invention relates to a field of personal comfort devices, specifically to personal cooling devices. It relates generally to a hands-free apparatus for selectively heating or cooling the human body trunk which is adapted to be worn under outer protective equipment or clothing items. The Special Personal Cooling device relates to an air distribution system for particular use by an individual who is required to wear restrictive, protective clothing and/or equipment in an ambient atmosphere conducive to excessive perspiration. The Special Personal Cooling Device called the Breezy Belt relates to a self-contained air distribution system for particular use by an individual to prevent heat stress and fatigue by evaporating body moisture and perspiration when exposed to high ambient temperature. The present invention as described has a particular cooling and evaporative effect.

### FEDERALLY SPONSORED RESEARCH

None.

### SEQUENCE LISTING OR PROGRAM

None.

### BACKGROUND-FIELD OF INVENTION AND PRIOR ART

As far as known and based on the novelty search summarized below, there are no Special Personal Cooling Device or the like. It is believed that this product is unique in its design and technologies.

### BACKGROUND

This background as to Personal Cooling Devices should be useful. Throughout history, people have used various methods to keep themselves cool on hot days and in hot environments, especially when engaged in strenuous activities. Simple methods of personal cooling include wearing a moistened bandanna around one's neck, shading oneself with a hat or parasol, fanning oneself, and using portable misting devices. All of these have at least one of the following disadvantages: They require the user to hold a device or to do something to get its benefit (which is not only bothersome, but such activity can generate more heat and exhaustion) They wet the user's clothing They provide only short-term relief They provide relatively poor cooling power

With the development of modern technologies, new ways have been found to produce a cooling effect. Some systems have employed elaborate mechanisms for pumping cool gels or fluids through a shirt or vest; others are essentially portable freon-type refrigerators, still others transfer coolness from a refrigerator or freezer to the body over time via phase-change substances. Some have proposed the use of compressed gas to create a stream of moving air across the skin. Peltier cells have also been explored for use in personal cooling devices. Still, each of these methods has serious drawbacks for the average user due to cost, complexity, and/or lack of effectiveness over time.

More recently, a device under the trademark Arctic Blast was introduced. This device is strapped to the front of a user's body, and blows air and a water mist up the front of the user's body. This approach has several major disadvantages: 1) it wets the user's shirt, 2) because it blows over the user's shirt, it either doesn't cool the user's torso or requires the user to remove his or her shirt to receive its benefit, 3) it destroys the user's hairdo, and 4) it is bulky, unattractive, and relatively expensive.

Individuals are oftentimes required to perform physical activity or duty in ambient atmosphere which is conducive to perspiration. Construction workers in hot climates oftentimes find themselves in such situations, however, they are not always required to wear heavy equipment, and the situation is such that they can take frequent rest breaks, seek out shaded areas, and hydrate when needed. Other individuals performing in such ambient temperatures are not often allowed the luxury of rest breaks and the like. These include military personnel, which are often required to wear tactical protective vests and multiple layers of clothing, in addition to the personal military equipment they must carry with them. These individuals are subjected to substantial fluid loss due to the clothing they are wearing, the equipment they are carrying, and the ambient thermal atmosphere. Cooling garments have been widely explored and include systems which attempt to blot the moisture and perspiration from the body, as well as incorporation an air flow system which is incorporated within a protective vest to distribute air yet such a system compromises the performance of the protective vest.

None of the above have a standalone pressurized movable flexible discharge outlet air system that is capable of channeling the exhausting air in a multi-directional, circular swirling pattern as it flows across and adjacent the body's surface area. Applicant's system is a lightweight and the flow of air itself cooling the body and also serving as an evaporative stream for the evaporation of moisture and perspiration.

When construction workers overheat in hot, humid climates, they not only lose effectiveness and risk heat exhaustion and heat stroke but can suffer significant cognitive impairment. While workers can remain safe by taking frequent rest breaks, time pressure to complete work frequently results in employees skipping rests, which can lead to heat related illness, some of which can be life threatening. For example, a 70-kilogram (154 lb.), physically fit individual engaged in very heavy work (such as digging with a shovel) generates about 2000 Btu/hr. (586 W) of heat. The heat capacity of tissue is about 3.5 kJ/kg. degrees C. (0.836 Btu/lb. degrees F.) and in the absence of any heat losses, absorbing this much heat will raise the body's core temperature from 37 degrees C. (98.6 degrees F.) to 40 degrees C. (104 degrees F.) in about 20 min. When the body's temperature reaches 104 degrees F., the result is heat stroke, which is a medical emergency. At this core temperature, the body loses its ability to regulate temperature, and cannot cool itself down. If untreated, heat stroke can lead to permanent disability or death. Less severe but still serious, heat exhaustion occurs at somewhat lower core body temperatures (i.e. the body's thermoregulatory system is still functioning). Symptoms include: heavy sweating, paleness, muscle cramps, fatigue, weakness, dizziness, headache, nausea and sometimes brief loss of consciousness (fainting). While less severe than heat exhaustion, even mild overheating can cause painful muscle cramps and heat rash.

Sweating cools the body in all but the very hottest of dry climates (Sawka, M. N and Pandolf, K. B. (2002) “Physical Exercise in Hot Climates: Physiology, Performance, and Biomedical Issues,” Chapter 3 “Physical Exercise in Hot Climates: Physiology, Performance, and Biomedical Issues. However, in hot, humid climates, the cooling effect of sweating is generally not effective because of the body's limited surface area and because the rates of mass transfer from the liquid phase (sweat) to vapor phase are low (because high ambient humidity lowers the driving force for the evaporation of water). While a person can be cooled in humid climates using air conditioning, ice, circulating liquid cooling systems, cold packs and phase change materials, these methods are frequently impractical because of their weight and size. For ice, cold packs and phase change materials, a refrigerator or freezer is needed to regenerate the materials, which may be unavailable. Further, these devices are not self-regulating and therefore do not respond to changes in the metabolic heat load; they keep cooling even when the worker is at rest, causing overcooling.

Three methods for personal cooling are: 1) ice/phase change packs, 2) liquid cooling systems and 3) forced air cooling. Clothing and protective equipment can severely restrict the flow of air, and this interferes with the evaporative cooling effects of sweating. This is bad enough in a hot, dry climate, but in hot, humid environments, this can be extremely uncomfortable (which is a distraction) and potentially dangerous (if it results in heat exhaustion or heat stroke). Heat stress when wearing clothing and protective gear and the effectiveness of existing personal cooling technologies (frequently referred to as microclimate technologies) has been studied to determine both the physiological and psychological effects of overheating on the ability of people to perform a wide variety of tasks that require different levels of exertion. The amount of metabolic heat generated depends on the task that the worker is performing. Effort is therefore broadly divided into four categories: 1) very light work generates 105-175 Watts [W]; 2) light work generates 175-325 [W]; 3) moderately heavy work generates 325-500 [W]; and 4) extremely hard work can produce more than 600 [W] of heat that must be removed. Especially for moderate to heavy work, frequent rests are required unless there is an active microclimate cooling technology being used by the worker. As expected, the harder the work, and the hotter and more humid the environment, the less time that can be spent working.

### Problem Solved

The improvement and problem solved as to Personal Cooling Devices are several. There has been a need for a self-contained apparatus which can be worn by an individual in such conditions which is light weight, comfortable, and distributes air flow about the body of the individual, including the chest and the back. Such a system needs to be responsive of the body and not be subject to shut down or collapse by the movement of the body. It is therefore a desideratum or requirement to provide a means and method of supplementing protective gear with cooling/heating equipment that alleviates uncomfortable aspects of wearing the gear resulting from an increase or decrease in the wearer's temperature while wearing the gear. There is a need for a light, portable cooling technology that can be used by first responders, construction workers, fire fighters, military personnel, landscape and lawn care contractors, and others to prevent heat exhaustion or heat stroke when working in hot or humid environments. There is a need for a novel portable, adjustable, flexible, pressurized air transfer system which is responsive to the movement of the body, which is lightweight, and which can be easily and comfortably worn beneath the clothing and equipment of the individual.

### PRIOR ART

There are numerous personal cooling systems to prevent heat overload and stress. The advantages, methods and construction have been well documented. The following is a list of some of these examples: refrigeration cycle based cooling, vortex cooling, thermoelectric based cooling, liquid cooled vests, passive (phase change) vests, and air cooled vests. But each have their own disadvantages.
With respect to refrigeration cycle based cooling, Rankine cycle refrigeration is an efficient method of heating and cooling. At least one variation has been deployed in combat operations. The system however does not support dismounted operations and requires integration into the vehicle's air-conditioning system or an air-conditioning system must be retrofitted to the vehicle if it is not so equipped.
With respect to vortex cooling, the Ranque-Hilsch—vortex tube is a simple device that has no moving parts. Vortex tubes are popular in the industry for spot cooling of machinery, processes and electronic equipment. A number of manufacturers have incorporated them into cooling garments as well as respiration systems and although simple and very effective, they do require high volumes of compressed air in order to operate.
With respect to thermoelectric devices (TEDs), TEDs have been used extensively in cooling and heating applications since their commercial inception in the 1950's. Typical applications include compact refrigerators/warmers, water coolers, electronic cooling and temperature references as well as biomedical systems. Unfortunately the current generation of TEDs is relatively inefficient when compared to Rankin cycle refrigeration systems on a power/heat in/heat out basis or coefficient of performance (COP).
With respect to liquid cooled vests, these vests have found extensive use in a variety of personnel cooling applications over the years. The cooling sources are typically refrigeration systems or thermal storage (ice water) based but there have been some examples utilizing TED s. Refrigeration and thermal based systems can limit their mobility in mass and/or space sensitive applications. Traditional TED based configurations have been power intensive primarily due to low efficiency and high interface resistance and losses.
With respect to passive cooled vests, these vests have found limited use for personnel cooling in certain military environments. The vest contains packages of eutectic salts or parafinitic hydrocarbons which absorb heat and cool by phase change and thermal storage.
With respect to air-cooled vests, certain designs of air cooled vests work primarily by removing heat trapped under the user's outerwear. This is effective with heavy or insulated outerwear or in cases where solar loads may be high, providing that the ambient air temperature is below or not significantly above body temperature. The user of the air-cooled vest must drink water constantly to keep from becoming dehydrated.

### PRIOR ART

A novelty search for the Special Personal Cooling device revealed no like devices. The search revealed:
A. U.S. Pat. No. 3,425,486 entitled Garments for controlling the temperature of the body was issued to Burton et al. in 1969. It shows a garment for controlling the temperature of the human body by cooling or heating the skin in which a network of flexible pipes for carrying a circulating liquid is supported by the garment in heat exchanging relationship with the body. Locating means in the form of fabric tunnels are provided which freely locate the pipes such that they can slidably move within the locating means and which restrain each pipe throughout its length in a circuitous serpentine configuration out of direct contact with the body for comfort, whereby the pipe circuit as a whole can deform as a result of bending or twisting of the pipes with a minimium restriction to deformation and stretching of the garment.
B. U.S. Pat. No. 4,691,762 entitled Personal temperature control system was issued to Elkins et al. in 1987. It demonstrates a personal temperature control system including a first heat exchanger adapted to be worn as a garment and a second heat exchanger adapted to interact with a temperature source, the first and second heat exchangers being interconnected through a pump and reservoir unit. The first heat exchanger together with the pump and reservoir are portable and in one embodiment the second heat exchanger is constructed to be fully portable. Specific devices including automatic quick release couplings interconnect the first heat exchanger to the second heat exchanger through the pump and reservoir. The fabrication of the first heat exchanger in helmet and vest portions is disclosed together with a control display unit housing the pump and reservoir and including an adjustable flow valve connected in parallel with the second heat exchanger. A preferred embodiment of the adjustable flow valve provides non-linear change in rate of flow upon adjustment.
C. U.S. Pat. No. 5,146,625 called a Cooling vest was issued to Steele et al. in 1992. Portrayed is a cooling vest having opposed front and back panels to substantially cover a user's torso, the panels being non-integral along at least a first side and a first shoulder. First shoulder connector means allows the front and back panels to be releasably connected to one another such that the first shoulder can open or close. A plurality of elongated pockets are provided on at least one of the panels and preferably both, each of which has an opening to receive a cooling pack into the pocket. By virtue of the foregoing open side and shoulder construction, the vest can be removed sideways after use allowing a user to wear protective headgear, such as a gas mask, until after the vest is removed and without having to attempt to remove the vest over their head. In one embodiment, each pocket has inner and outer walls, each wall having a structural layer and an insulation layer. The insulation layer of the inner wall inhibits too rapid cooling of the user's torso which might otherwise occur, while the cooling by the gel packs.
D. U.S. Pat. No. 5,320,164 called a Body heating and cooling garment was issued to Szczesuil et al. in 1994. Provided here is a body heating/cooling garment which utilizes fluid-carrying tubes and provides both air and vapor permeability to promote convective heat transfer while also providing conductive heat transfer.
E. U.S. Pat. No. 5,533,354 entitled Personal Comfort Apparatus was issued to Pirkle in 1996. This demonstrates a personal cooling apparatus comprises a harness constructed of perforated tubing to provides air circulation over the body of a wearer. The tubing has at least one fin adjacent the perforations to enhance the induction of flow of ambient air by gas escaping through the perforations. The tubing is extruded and has a footing strip formed on it to maintain it in a specific position and to permit the tubing to be attached to the interior of a garment. The effect is to create, at each perforation, a small fan, and the harness thereby circulates air against the skin of the wearer. The tubing can be sewn onto the inner or outer surface of a lightweight garment.
F. A publication No. 20020153126 for a device named Multi-functional mobile climate control assembly for personal use was completed by Clemente. This shows an improved, multi-functional, portable, electronic climate control device to maintain personal body temperature at a desired level in relationship to different environments. The portable electronic control device can combine a refrigeration system with a circulation pump in fluid communication with a garment-like vest to provide personal cooling below surrounding ambient temperature, or include an electronic heating element with circulating pump in fluid communication with a garment-like vest to maintain personal body temperature above surrounding environment.
G. U.S. Pat. No. 6,543,247 named a Waist-mounted evaporative personal cooler was issued to Strauss in 2003. It demonstrated a waist-mounted evaporative personal cooling device designed to cool the back of a user, comprises a blower (25), a liquid reservoir (29), a means to deliver liquid from the reservoir a mist of droplets into blower-forced air (33) or directly onto the skin area to which the forced air will be directed (45), and a duct (27) to guide forced air under the user's shirt or blouse and directly onto or across the skin of the user's back. The device improves on prior art coolers by delivering a powerful evaporative cooling effect directly to a user's back, while being compact, comfortably wearable, and requiring the user to do little or nothing to get its benefit.
H. U.S. Pat. No. 7,124,593 entitled Temperature conditioning apparatus for the trunk of a human body was issued to Feher in 2006. It shows a temperature conditioning apparatus for the human body includes a vest or other clothing unitary with a thermoelectric or Stirling cycle heat pump worn by the user. The unit is powered by a battery source worn on the user's belt or other part of his or her body, or by an externally-mounted electrical energy source, for example, in a vehicle. The vest has front and rear panels with an air flow layer and permeable inside layer that accept and release conditioned air to the user. The vest may be used with body armor or other protective layers, that is, the vest may be worn underneath body armor or body armor may be built into the vest, or the vest may be used without body armor to cool the user in an exceptionally hot environment such as a non-air conditioned space in hot weather.
I. A publication No. 20080141428 for a device named Cooling System for Body Armour was completed by Kapah et al. Here is shown a system for providing streaming air to evaporate perspiration from a wearer of personal armour. The system incorporates a set of voluminous layers for wearing beneath the armour, one of which is enveloped voluminous layer. The envelope is perforated in the direction of said wearer, such that an air blower forces air into the perforation and thence onto the body of the wearer.
J. A publication No. 20080306433 for a device named Body Temperature Controlling System was completed by Cesaroni. It teaches a body temperature controlling system comprising at least one member receiving a flow of gas from at least one blower in communication with said at least one member, said at least one member directing said flow of gas onto a wearer thereof.
K. U.S. Pat. No. 9,121,414 entitled Low-profile blowers and methods was issued to Lofy et al. This demonstrates a blower configured to be positioned in confined spaces and to provide ventilation of a fluid, such as temperature-controlled air, is disclosed. In various embodiments, the blower is configured to have a reduced axial thickness, which can be desired in such confined spaces. In some embodiments, the blower has an integral filter, a wire channel for the routing of one or more wires, and/or an exposed backplate. In some embodiments, the blower has a snap-fit circuit board, containment system for mounting the motor, one or more vanes for directing fluid flow, shrouded impeller, and/or integrated connector.
L. U.S. Pat. No. 9,308,121 called a Helical Air Distribution System was issued to Clemente in 2016. Here is portrayed a self-contained helical air distribution system for the body of an individual which can distribute air over both the chest and back of the individual, the system including a battery operated blower fan in communication with the plenum and manifold, the manifold having a plurality of tubular distribution conduits, each conduit having a capped end, the conduits extending over the chest and back of the body, the conduits formed with a spiral helix cut allowing the tubular conduits to react to the motion of the human body, the spiral helix cuts reacting to such movement, thereby allowing air to selectively escape from the expansion of these cuts providing a cooling and evaporate effect. With slight adaptation the air distribution system can distribute heated air and be used to control the ambient temperature about inanimate objects, such as computers, electronic instruments, windshields, and car seats.
M. U.S. Pat. No. 9,488,447 entitled Personal cooling device for use with body armor was issued to Shelton et al. in 2016. Shown here is a personal cooling device with a network of tubular members, each tubular member having an inner surface defining a flowpath, an outer surface, and at least two channels extending between the flowpath and the outer surface. The network has an inlet. The at least two channels of each tubular member have differently-sized volumes, with the channels having the larger volumes closer to the network inlet than the channels having the smaller volumes. The device also includes a pump having an inlet and an outlet, and a length of connection tubing in fluid communication with the outlet of the pump and the inlet of the network of tubular members.
N. U.S. Pat. No. 9,635,889 entitled a Cooling garment was issued to Copeland et al. in 2017. This demonstrates a cooling garment, comprising: a moisture-wicking under layer; and an impermeable outer layer, wherein the impermeable outer layer is attached to the moisture-wicking under layer forming at least one channel within the garment having a wetted perimeter of at most five inches; and an above ambient pressure gas supply operably attached to the channel. The present invention also relates to the cooling shirt or vest garment, comprising: a moisture-wicking under layer and an impermeable outer layer, wherein the outer layer is attached to the under layer forming a plurality of channels.
O. U.S. Pat. No. 9,851,113 entitled Air distribution system for individual cooling was issued to Clemente in 2017. This demonstrates a portable, adjustable, and flexible waist mounted, self-contained air distribution system for an individual which can distribute pressurized air over the upper or lower body of an individual, directly against the skin or the clothing of the individual, the system including a portable rechargeable battery operated blower fan in communication with a plenum and manifold, the manifold having a primary adjustable and flexible exhaust outlet openings that spreads, throws and disburses a pressurized air flow selectively over the upper or lower body of an individual, thereby allowing air to selectively provide a cooling and evaporate effect.

None of the above have a portable, stand alone, pressurized, adjustable, flexible discharge outlet air system that is capable of channeling the exhausting air directly or indirectly over the body or the skin of an individual through adjustable, flexible, waist mounted primary exhaust outlet openings that spreads, throws and disburses pressurized air over the upper or lower body. As can be observed, none of the prior art has anticipated or caused one skilled in the art of cooling and heating personal devices to see this new invention by Sanford as obvious to a person skilled in the ordinary art of the industry. Other examples of personal cooling and thermal controlling devices and uses are still to be within the scope and spirit shown here.

### SUMMARY OF THE INVENTION

This invention is a Special Personal Cooling device. Taught here are the ways a hands-free Special Personal Cooling device may be use in various applications to cool and individual. Applicant's system is a lightweight plenum manifold system which spreads, throws and distributes a flow of pressurized air about the upper or lower body, of an individual, the flow of air itself capable of cooling the skin directly or the clothing worn by the individual by providing a pressurized air stream that evaporates moisture and perspiration.

The preferred embodiment of the Special Personal Cooling device made of resilient and durable materials and comprised of: (a) a belt system including a belt, clip receiver and belt clip; (b) a power system including a pair of battery containers, a re-chargeable battery, and container cover; (c) a fan system including a fan base, a fan drive shaft and electric motor, a fan, a fan cover, and a finger guard; (d) a means to mechanically and integrally secure the fan system, power system and belt system together such as fasteners or integrally molding the systems together as an assembly; and (e) an electrical control system for controlling the power from the battery to the motor and fan through the shaft including but not limited to wiring and typical wire connectors, a speed control, a power plug-in, and a kill switch wherein the Special Personal Cooling device can be secured onto a torso of a user, secured to the shirt of the user, worked with a shirt plenum as an exit feature of the fan system and fan portion inside the shirt with a shirt cloth clip, and turned on through the speed control to provide a controlled amount of air into the interior of a shirt and to allow the air to aid and to improve the natural cooling process of the user by providing the additional airflow across the surface of the skin of the user.

The newly invented Special Personal Cooling device for various applications may be manufactured at low volumes by very simple means and in high volume production by more complex and controlled systems.

### OBJECTS AND ADVANTAGES

There are several objects and advantages of the Special Personal Cooling device. There are currently no known personal cooling or thermal control devices that are effective at providing the objects of this invention.

The Special Personal Cooling Device has various advantages and benefits:

| Item | Advantages |
|---|---|
| 1 | Is compact and lightweight-weighs 1.2 lbs. with |
| | batteries |
| 2 | Can be used to cool the body, neck, and head and |
| | pants too with up-coming attachment |
| 3 | Is easy to use, maintain and carry with |
| | associated branded sling bag |
| 4 | Has a 12 volt fan motor (battery sold separately) |
| | compatible with other 12 v electric systems |
| 5 | Maintains body temperature at a safe level and |
| | can lower the perceived temperature up to 15 to |
| | 20 degrees |
| 6 | Protects personnel in extreme hot environments up |
| | to around 110 degrees heat index |
| 7 | The buffer of ambient air holds the garment of |
| | the wearer away from the body and skin even in a |
| | high heat index |
| 8 | Improves workers safety, performance, alertness |
| | and concentration |
| 9 | Allows for one size to easily adjust to many |
| | users. |
| 10 | Is a Quiet design, won't interfere with |
| | conversation |
| 11 | Will not interfere with most normal activities |
| | and operates hands-free |
| 12 | Is a modular design that allows for easy cleaning |
| | and user defined ergonomic comfort |

Finally, other advantages and additional features of the present Special Personal Cooling device will be more apparent from the accompanying drawings and from the full description of the device. For one skilled in the art of personal cooling, heating and thermal conditioning devices, it is readily understood that the features shown in the examples with this product are readily adapted to other types of personal cooling devices.

### BRIEF DESCRIPTION OF THE DRAWINGS

The accompanying drawings, which are incorporated in and constitute a part of this specification, illustrate an embodiment of the Special Personal Cooling Device for various applications device that is preferred. The drawings together with the summary description given above and a detailed description given below serve to explain the principles of the Special Personal Cooling Device. It is understood, however, that the Special Personal Cooling Device is not limited to only the precise arrangements and instrumentalities shown.

FIGS. 1 A through 1 D are sketches of the general special personal cooling device called Breezy Belt.

FIGS. 2 A and 2 B are sketches of the special personal cooling device with components and features noted.

FIGS. 3 A through 3 D are more sketches of the special personal cooling device with the components and features shown from a top, front, side, and isometric view.

FIG. 4 is a sketch of the special personal cooling device with an exploded view of the components.

FIGS. 5 A through 5 G are sketches of the prototype special personal cooling device in use.

FIGS. 6 A through 6 F are sketches of prior art related to personal cooling devices.

### DESCRIPTION OF THE DRAWINGS—REFERENCE ITEMS

The following list refers to the drawings:

TABLE B
Reference numbers

| Ref # | Description |
|---|---|
| 30 | special personal cooling device 30 called |
| | Breezy Belt |
| 31 | prototype 31 of special personal cooling |
| | device 30 |
| 33 | isometric 33 of special personal cooling |
| | device 30 |
| 35 | exploded view 35 of special personal cooling |
| | device 30 |
| 40 | shirt plenum 40, exit feature of the container |
| | and fan portion inside the shirt; |
| 42 | shirt cloth clip 42 |
| 44 | fan 44 |
| 45 | finger guard 45 |
| 46 | battery 46-12-volt, 6 volt, 18 volt or the |
| | like, rechargeable or standard replaceable, |
| | and Alkaline battery, Lead-acid battery, |
| | Lithium-ion battery, Nickel-cadmium battery, |
| | Zinc chloride battery, or the like |
| 47 | battery container 47 |
| 47A | battery cover 47A over battery 46 in container |
| | 47 |
| 48 | kill switch 48 |
| 50 | clip receiver 50 for the belt clip 52 |
| 52 | belt clip 52 |
| 54 | shirt 54 of the operator 100 |
| 56 | speed controller 56 |
| 56A | pre-selected four (4) position push button |
| | speed controller 56A |
| 58 | power plug-in 58 |
| 59 | set of wiring and typical wire connectors 59 |
| 60 | belt 60 |
| 64 | fan cover 64 |
| 66 | fan base 66 |
| 68 | fan drive shaft 68 |
| 70 | electric motor 70 |
| 100 | operator/user 100 |
| 110 | shirt-fan off 110 |
| 120 | shirt expanded-fan on 120 |
| 130 | optional leg ducts 130 |
| 132 | aperture or opening 132 into plenum for |
| | optional leg ducts 130 |
| 150 | prior art 150 U.S. Pat. No. 9,851,113 |
| 151 | prior art 151 U.S. Pat. No. 9,488,447 |
| 152 | prior art 152 U.S. Pat. No. 6,543,242 |
| 153 | prior art 153 U.S. Pat. No. 4,691,762 |
| 154 | prior art 154 U.S. patent Application |
| | 2002/0153126 |
| 155 | prior art 155 U.S. Pat. No. 9,308,121 |

### DETAILED DESCRIPTION OF PREFERRED EMBODIMENT

The present development is a Special Personal Cooling device called the Breezy Belt. This invention relates to a field of personal comfort devices, specifically to personal cooling devices. It relates generally to a hands-free apparatus for selectively heating or cooling the human body trunk which is adapted to be worn under outer protective equipment or clothing items. The Special Personal Cooling device relates to an air distribution system for particular use by an individual who is required to wear restrictive, protective clothing and/or equipment in an ambient atmosphere conducive to excessive perspiration. The Special Personal Cooling Device called the Breezy Belt relates to a self-contained air distribution system for particular use by an individual to prevent heat stress and fatigue by evaporating body moisture and perspiration when exposed to high ambient temperature. The present invention as described has a particular cooling and evaporative effect.

The advantages for the Special Personal Cooling device 30 are listed above in the introduction. Succinctly the benefits are that the device:
A. Is compact and lightweight—weighs 1.2 pounds with batteries.
B. Can be used to cool the body, neck, and head and pants too with up-coming attachment.
C. Is easy to use, maintain and carry with associated branded sling bag.
D. Has a 12 volt fan motor (battery sold separately) compatible with other 12 v electric systems.
E. Maintains body temperature at a safe level and can lower the perceived temperature up to 15 to 20 degrees.
F. Protects personnel in extreme hot environments up to around 110 degrees heat index.
G. The buffer of ambient air holds the garment of the wearer away from the body and skin even in a high heat index.
H. Improves workers safety, performance, alertness and concentration.
I. Allows for one size to easily adjust for many users.
J. Is a Quiet design, won't interfere with conversation.
K. Will not interfere with most normal activities and operates hands-free.
L. Is a modular design that allows for easy cleaning and user defined ergonomic comfort.
M. Hands free for ease of movement.

The preferred embodiment of the Special Personal Cooling device 30 made of resilient and durable materials and comprised of: (a) a belt system including a belt 60, clip receiver 50, and belt clip 52; (b) a power system including a pair of battery containers 47, a re-chargeable battery 46, and container cover 47A; (c) a fan system including a fan base 66, a fan drive shaft 68, and an electric motor 70, a fan 44, a fan cover 64, and a finger guard 45; (d) a means to mechanically and integrally secure the fan system, power system and belt system together such as fasteners or integrally molding the systems together as an assembly; and (e) an electrical control system for controlling the power from the battery 46 to the motor 70 and fan 44 through the shaft 68 including but not limited to a set of wiring and typical wire connectors 59, a speed controller 56, a power plug-in 58, and a kill switch 48 wherein the Special Personal Cooling device 30 can be secured onto a torso of a user 100, secured to the shirt 54 of the user 100, worked with a shirt plenum 40 as an exit feature of the fan system and fan portion inside the shirt with a shirt cloth clip 42, and turned on through the speed controller 56 to provide a controlled amount of air into the interior of a shirt and to allow the air to aid and to improve the natural cooling process of the user by providing the additional airflow across the surface of the skin of the user 100.

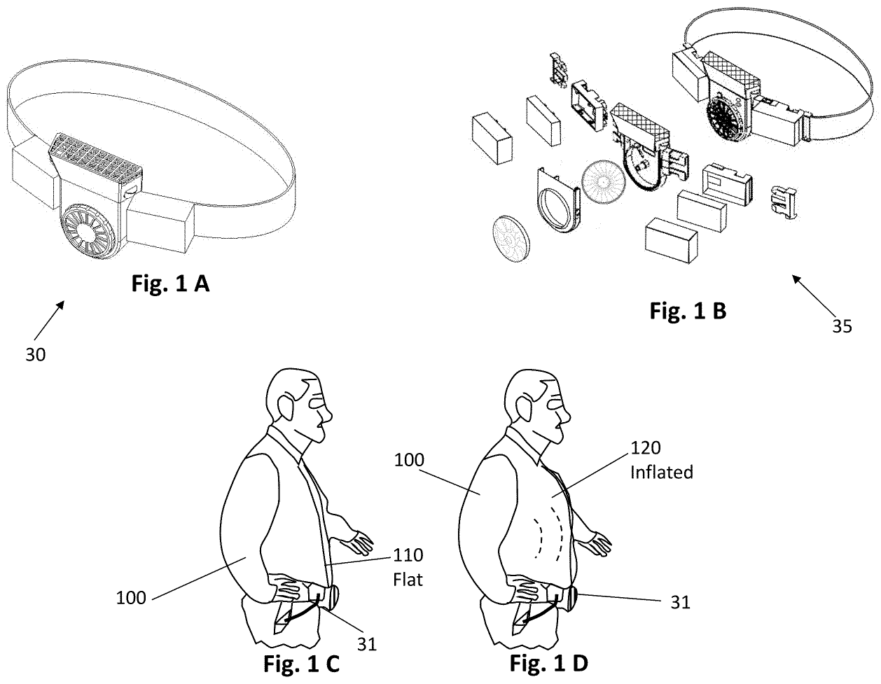

There is shown in FIGS. 1-6 a complete description and operative embodiment of the Special Personal Cooling device 30. In the drawings and illustrations, one notes well that the FIGS. 1-6 demonstrate the general configuration and use of this product. The various example uses are in the operation and use section, below.

The accompanying drawings, which are incorporated in and constitute a part of this specification, illustrate an embodiment of the Special Personal Cooling device 30 that is preferred. The drawings together with the summary description given above and a detailed description given below serve to explain the principles of the Special Personal Cooling device 30. It is understood, however, that the Special Personal Cooling device 30 is not limited to only the precise arrangements and instrumentalities shown. Other examples of personal cooling and thermal controlling devices and uses are still understood by one skilled in the art of cooling and heating personal devices to be within the scope and spirit shown here.

FIGS. 1 A through 1 D are sketches of the general special personal cooling device 30 called Breezy Belt. In these lead-off sketches are shown: a special personal cooling device 30 called Breezy Belt; a prototype 31 of special personal cooling device 30; an exploded view 35 of special personal cooling device 30; a feature of shirt—fan off 110; and a feature of shirt expanded—fan on 120.

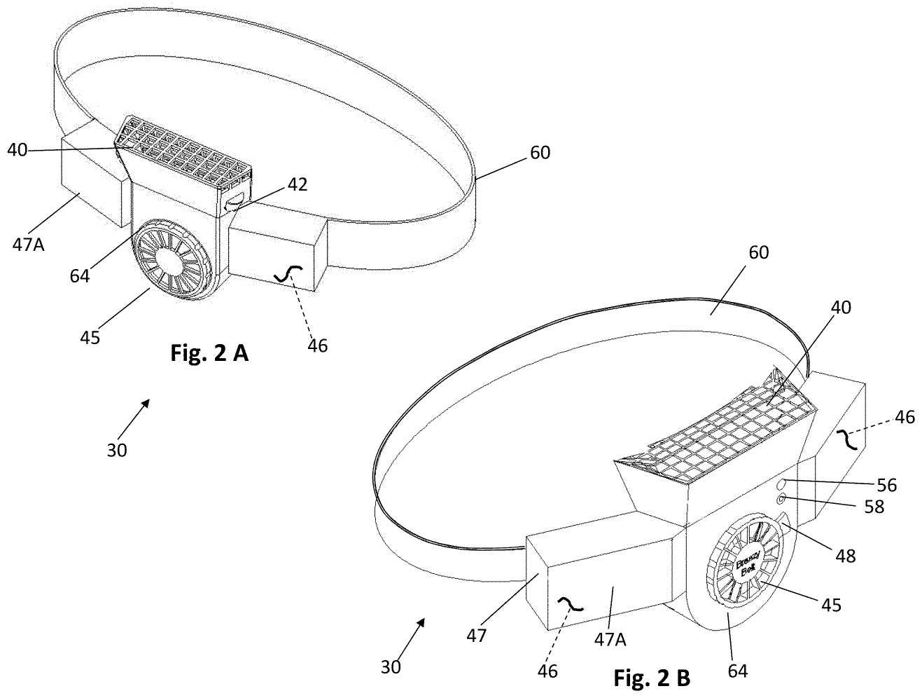

FIGS. 2 A and 2 B are sketches of the special personal cooling device 30 with components and features noted. Demonstrates here are components and features including: a special personal cooling device 30 called Breezy Belt; a shirt plenum 40, exit feature of the container and fan portion inside the shirt; a shirt cloth clip 42; a finger guard 45; a battery 46; a battery container 47; a battery cover 47A over battery 46 in container 47; a kill switch 48; a clip a speed controller 56; a power plug—in 58; a set of wiring and typical wire connectors 59; a belt 60; and a fan cover 64. Note that the battery 46 could be a 12 volt, 6 volt, 18 volt or the like and could be rechargeable or a standard replaceable type. Various types include an Alkaline battery, Lead-acid battery, Lithium-ion battery, Nickel-cadmium battery, Zinc chloride battery, or the like

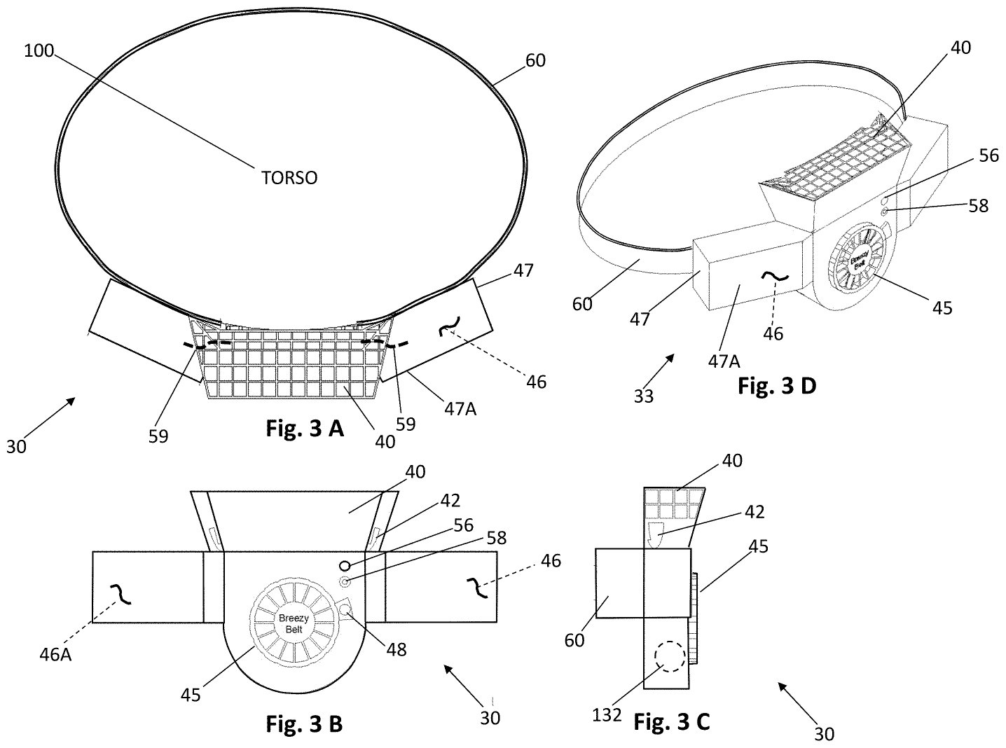

FIGS. 3 A through 3 D are more sketches of the special personal cooling device 30 with the components and features shown from a top, front, side, and isometric view. Provided in these views are: a special personal cooling device 30 called Breezy Belt; an isometric 33 of special personal cooling device 30; a shirt plenum 40, exit feature of the container and fan portion inside the shirt; a shirt cloth clip 42; a finger guard 45; a 12 volt battery 46; a battery container 47; a battery cover 47A over battery 46 in container 47; a kill switch 48; a speed controller 56; a power plug—in 58; a set of wiring and typical wire connectors 59; a belt 60; and a fan cover 64. Various resilient and durable materials anticipated for the device 30. The belt can be natural or synthetic leather or the like, fabrics such as cotton webbing, nylon, polyester, composite materials, etc. The plenum, fan containers, and battery containers can be one of the plethora of plastics such as poly vinyl chloride, ABS, polyesters, nylon and reinforced nylon, light metals such as aluminum, steel or the like, and various composite materials. The fan itself should be a plastic, composite material or light weight metal that can handle the centrifugal forces encountered when the blade or impeller is spinning. Likewise, depending on how the manufacturing processes and materials are matched up, there can be either stampings, castings or integral molding that connect the fan, belt and battery sub-systems or sub-assemblies. If not, small threaded fasteners, clips, pop rivets, plastic rods and spin over or smashed heads can be used to connect the sub-assemblies and to secure them into a one piece assembly for the Special Personal Cooling device. Plastics and composites can be friction, ultrasonic, or heat welded. Likewise, some adhesives may serve to connect the sub-assemblies and manufacture the full assembly.

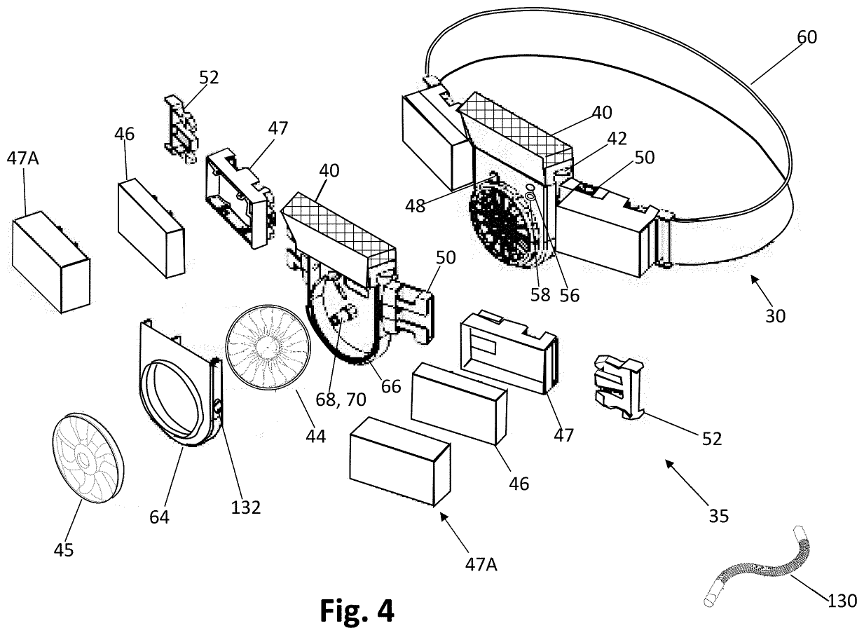

FIG. 4 is a sketch of the special personal cooling device 30 with an exploded view 35 of the components. This sketch clearly shows: a special personal cooling device 30 called Breezy Belt; an exploded view 35 of special personal cooling device 30; a shirt plenum 40, exit feature of the container and fan portion inside the shirt; a shirt cloth clip 42; a fan 44; a finger guard 45; a 12 volt battery 46; a battery container 47; a battery cover 47A over battery 46 in container 47; a kill switch 48; a clip receiver 50 for the belt clip 52; a belt clip 52; a speed controller 56; a power plug—in 58; a set of wiring and typical wire connectors 59; a belt 60; a fan cover 64; a fan base 66; and a fan drive shaft 68 and electric motor. As one skilled in the art of any battery operated device with a small electric motor knows, the 12 volt batteries 46, the small electric drive motor and shaft 68 that turns the fan 44, the speed controller 56, power plug 58 and kill switch 48 al must be electrically connected by a wiring harness or a set of discrete wires 59. The electrical wiring system or means to transfer the electric energy from the batteries 46 to the motor and shaft 68 and then permit the rotating shaft to mechanically turn the fan 44 is not a new or unique idea. There are a plethora of ways to engineer and design this part of the Special Personal Cooling device 30. For one skilled in the art of electrically powered fans with simple speed controls and kill switches, it is well known art and need not be limited or described herein with this cooling device 30. The electrical means to take the electrical power from the batteries and power the motor and shaft 68 connected to the fan is needed in the device 30 but the many ways and manners of doing so are well understood by the persons skilled in the art of cooling devices. Therefore, the means need not be intricately deigned here no is claimed as unique.

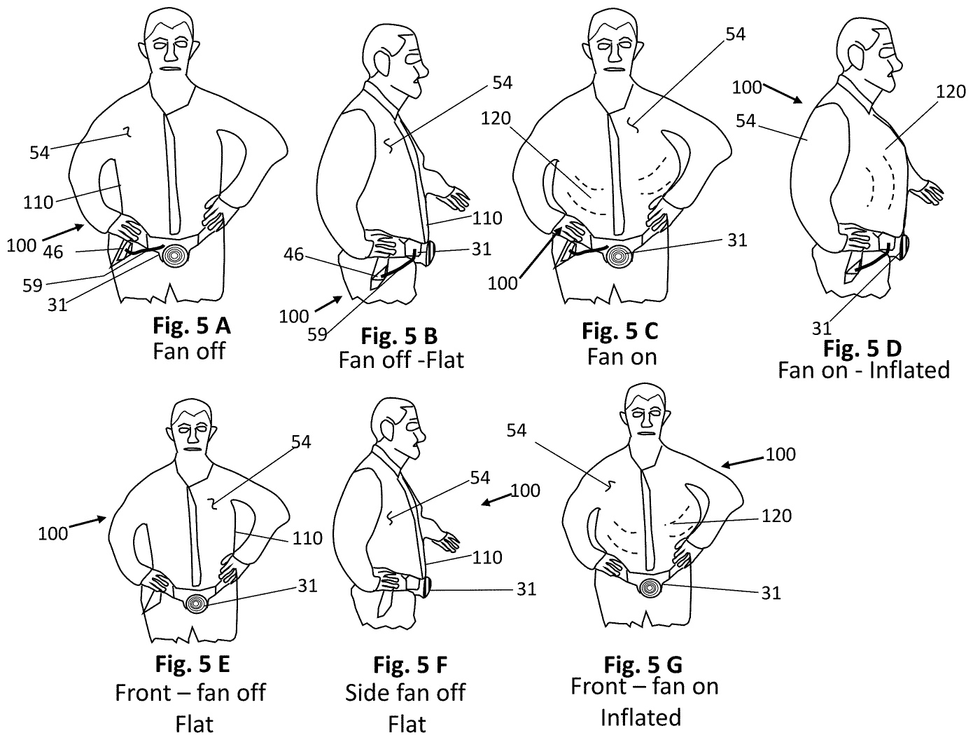

FIGS. 5 A through 5 G are sketches of the prototype special personal cooling device in use. These sketches are discussed below in the Operation Section.

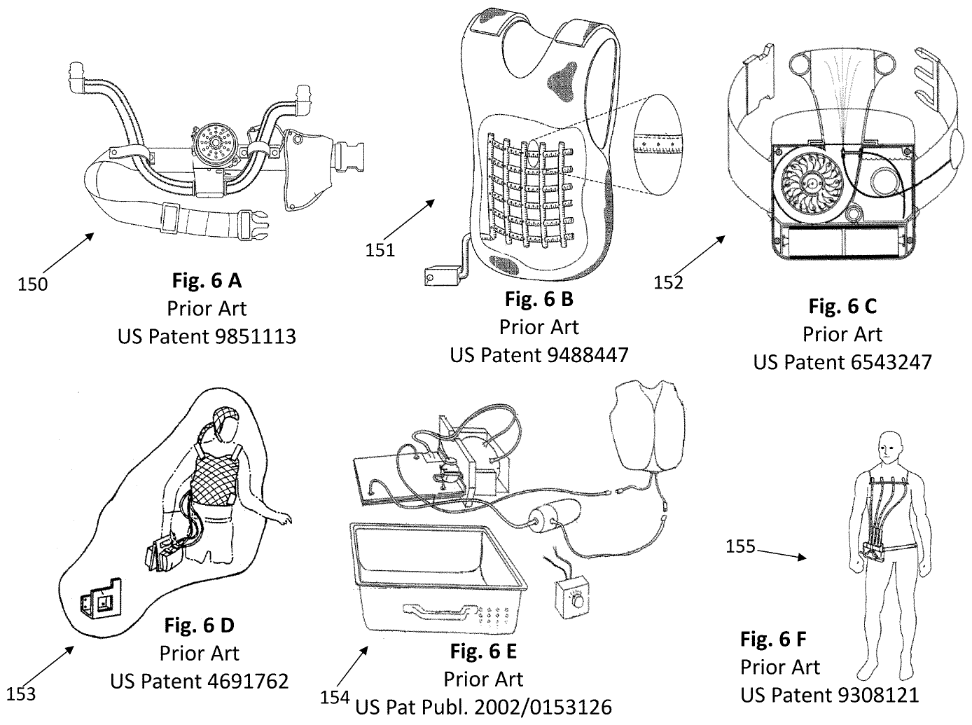

FIGS. 6 A through 6 F are sketches of prior art related to personal cooling devices. Here former patents and applications for various Personal Cooling devices are shown. These include: a prior art 150 U.S. Pat. No. 9,851,113; a prior art 151 U.S. Pat. No. 9,488,447; a prior art 152 U.S. Pat. No. 6,543,242; a prior art 153 U.S. Pat. No. 4,691,762; a prior art 154 US Patent Application 2002/0153126; and a prior art 155 U.S. Pat. No. 9,308,121. As can be seen, the Special Personal Cooling device 30 is a unique combination device.

The details mentioned here are exemplary and not limiting. Other specific components and manners specific to describing a Special Personal Cooling Device 30 may be added as a person having ordinary skill in the field of the art of cooling devices, personal care devices and the like and their uses well appreciates.

### OPERATION OF THE PREFERRED EMBODIMENT

The Special Personal Cooling Device 30 has been described in the above embodiment. The manner of how the device operates is described below. One notes well that the description above and the operation described here must be taken together to fully illustrate the concept of the Special Personal Cooling Device 30. The preferred embodiment of the Special Personal Cooling device 30 made of resilient and durable materials and comprised of: (a) a belt system including a belt 60, clip receiver 50, and belt clip 52; (b) a power system including a pair of battery containers 47, a re-chargeable battery 46, and container cover 47A; (c) a fan system including a fan base 66, a fan drive shaft 68, and an electric motor 70, a fan 44, a fan cover 64, and a finger guard 45; (d) a means to mechanically and integrally secure the fan system, power system and belt system together such as fasteners or integrally molding the systems together as an assembly; and (e) an electrical control system for controlling the power from the battery 46 to the motor 70 and fan 44 through the shaft 68 including but not limited to wiring and typical wire connectors, a speed controller 56, a power plug-in 58, a set of wiring and typical wire connectors 59; and a kill switch 48 wherein the Special Personal Cooling device 30 can be secured onto a torso of a user 100, secured to the shirt 54 of the user 100, worked with a shirt plenum 40 as an exit feature of the fan system and fan portion inside the shirt with a shirt cloth clip 42, and turned on through the speed controller 56 to provide a controlled amount of air into the interior of a shirt and to allow the air to aid and to improve the natural cooling process of the user by providing the additional airflow across the surface of the skin of the user 100.

The Special Personal Cooling device 30 known as the Breezy Belt operates in the following manner: Each of the pair of 12 volt batteries 46 are pre-charged. Next the each of the batteries 46 is placed into the battery container 47 and the respective battery cover 47A is placed over each of the battery 46 in the container 47. Alternatively, if the batteries 46 are in place, they may be re-charged by connecting the power plug 58 to an appropriate source of electric power (such as a transformer and cigarette lighter/power plug or the like. Once the batteries 46 are charged and ready, the device 30 is placed and secured around a torso of the operator/user 100. The belt is held firmly in place by securing the belt clip 52 into the clip receiver 50 and adjusting the length of the belt 60. Next the shirt 54 of the operator 100 is brought around the shirt plenum 40, exit feature of the container and fan portion inside the shirt of the device 30 and attached to the shirt cloth clip 42 on each side of the plenum 40. Excess shirt 54 may be tucked in or will soon billow outward when the device 30 is engaged. Now the Special Personal Cooling device 30 is in place and ready to operate. The speed controller 56 switch is engaged and the dial can be adjusted for more or less speed (which controls the volume and cubic feet per minute (CFM) of air being discharged from the device 30 through the plenum 40. If more air is desired, the speed controller dial 56 is increased. If less air or CFM is needed the speed controller 56 the dial is turned “down” and the CFM is reduced. At any time, the device 30 can be fully stopped or disengaged by hitting the kill switch 48 which interrupts the power from the batteries 46 to the fan 44. During the operation, the Special Personal Cooling device 30 can be plugged into an alternative power source though the power plug-in 58 and a set of wiring and typical wire connectors 59. This will charge the batteries 46 and increase run time for the device 30. The alternative source can be a plug on a mower, a cigarette lighter in a truck or vehicle, or the like. When complete and finished using the Special Personal Cooling device 30, the shirt 54 is unsecured at the shirt clips 42, the belt 60 is disengaged at the belt clip 52 and the clip receiver 50, and the batteries 46 are removed from the container 47 and recharged. When and if desired, an optional set of leg ducts 130 can be connected at the aperture or opening 132 into plenum for optional leg ducts 130 and inserted into the pant leg of the trousers of an operator 100. These can divert air from the device 30 into the leg regions for cooling the lower extremities. It can be noted that batteries 46 will be permanently glued in their containers 47. It is the complete and assembled battery containers 47 that can either be charged while clipped into the unit 30 or removed for charging. The fan unit 30 can also be worn without the batteries 46 to be lighter. Power would then be drawn from an external source such as associated 12v machinery or a satellite battery pack connected by a power source wire. Also, the units 30 are designed with either a speed dial controller 56 or a pre-selected four (4) position push button speed controller 56A. The kill switch 48 is only disengaged when the finger guard 45 is removed for cleaning.

FIGS. 5 A through 5 G are sketches of the prototype special personal cooling device in use. The components and features shown in the views are a prototype 31 of special personal cooling device 30; an operator/user 100; a shirt 54 of the operator 100; a feature of shirt—fan off 110; and feature of shirt expanded—fan on 120. The Figures show:

| FIGURE | Description |
|---|---|
| Fig. 5 A | Front View Special Personal Cooling device |
| | ready but Fan Off, no action or cooling |
| Fig. 5 B | Side View Special Personal Cooling device ready |
| | but Fan Off, no action or cooling |
| Fig. 5 C | Front View Special Personal Cooling device Fan |
| | On an the action of cooling underway |
| Fig. 5 D | Side View Special Personal Cooling device Fan |
| | On an the action of cooling underway |
| Fig. 5 E | Another Front View Special Personal Cooling |
| | device ready but Fan Off, no action or cooling |
| Fig. 5 F | Another Side View Special Personal Cooling |
| | device ready but Fan Off, no action or cooling |
| Fig. 5 G | Another Front View Special Personal Cooling |
| | device Fan On an the action of cooling underway |

Many uses are anticipated for the Special Personal Cooling Device 30. Portable cooling methods and/or systems would be beneficial not only for lawn care, landscaping, and military applications but also, for example, in sports (e.g. cooling athletes during training and competition), industrial and medical applications. Some examples, and not limitations, are shown in the following Table.

| Item | Uses |
|---|---|
| 1 | Landscapers and outdoor workers |
| 2 | Industrial workers |
| 3 | First Responders |
| 4 | Construction workers |
| 5 | Handicapped |
| 6 | Welders |
| 7 | Farmers |
| 8 | Miners |
| 9 | Medical patients |
| 10 | Athletes |
| 11 | Motor sports |
| 12 | Sports enthusiasts |
| 13 | Firefighters |
| 14 | Military |
| 15 | Law enforcement |

With this description it is to be understood that the Special Personal Cooling Device 30 is not to be limited to only the disclosed embodiment of product. The features of the Special Personal Cooling Device 30 are intended to cover various modifications and equivalent arrangements included within the spirit and scope of the description.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described above in the foregoing paragraphs.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

The present invention contemplates modifications as would occur to those skilled in the art. While the disclosure has been illustrated and described in detail in the figures and the foregoing description, the same is to be considered as illustrative and not restrictive in character, it being understood that only selected embodiments have been shown and described and that all changes, modifications and equivalents that come within the spirit of the disclosures described heretofore and or/defined by the following claims are desired to be protected.

What is claimed is:

1. A Special Personal Cooling device made of a resilient and durable materials and comprised of:
(a) a belt system;
(b) a power system;
(c) a fan system;
(d) a means to mechanically and integrally secure the fan system, power system and belt system together; and
(e) an electrical control system for controlling the power from the battery to the motor and fan
wherein the Special Personal Cooling device can be secured onto a torso of a user, secured to the shirt of the user, worked with a shirt plenum as an exit feature of the fan system and fan portion inside the shirt with a shirt cloth clip, and turned on through the speed control to provide a controlled amount of air into the interior of a shirt and to allow the air to aid and to improve the natural cooling process of the user by providing the additional airflow across the surface of the skin of the user.

2. The Special Personal Cooling device in claim 1 further comprised with leg ducts (130).

3. The Special Personal Cooling device in claim 1 wherein durable and resilient material of the belt is selected from a group consisting of natural leather, synthetic leather, cotton webbing, nylon, polyester, and composite materials.

4. The Special Personal Cooling device (30) in claim 1 wherein the durable and resilient material of the plenum, fan containers, and battery containers is selected from a group consisting of poly vinyl chloride (pvc), acrylonitrile butadiene styrene (ABS), polyester, nylon, reinforced nylon, aluminum, steel and composite materials.

5. The Special Personal Cooling device in claim 1 wherein the durable and resilient material of the fan is selected from a group that can handle expected centrifugal forces, the group consisting of poly vinyl chloride (pvc), acrylonitr butadiene styrene (ABS), polyester, nylon, reinforced nylon, aluminum, steel and composite materials.

6. The Special Personal Cooling device (30) in claim 1 wherein the battery type is selected from a group consisting of 12-volt, 6 volt, and 18 volt.

7. The Special Personal Cooling device (30) in claim 1 wherein the battery type is selected from a group consisting of a rechargeable type and a standard replaceable type.

8. The Special Personal Cooling device (30) in claim 1 wherein the battery material type is selected from a group consisting of Alkaline battery, Lead-acid battery, Lithium-ion battery, Nickel-cadmium battery, and Zinc chloride battery.

9. The Special Personal Cooling device (30) in claim 1 wherein the means to mechanically and integrally secure is selected from a group consisting of small threaded fasteners, clips, pop rivets, and plastic rods and spin over heads.

10. A Special Personal Cooling device (30) made of resilient and durable materials and comprised of:
(a) a belt system including a belt (60), clip receiver (50) and belt clip (52);
(b) a power system including a pair of a battery containers (47), a battery (46), and container cover (47A);
(c) a fan system including a fan base (66), a fan drive shaft (68) and electric motor (70), a fan (44), a fan cover (64), and a finger guard (45);
(d) a means to mechanically secure the fan system, power system and belt system; and
(f) an electrical control system
wherein the Special Personal Cooling device can be secured onto a torso of a user (100), secured to the shirt (54) of the user (100), and turned on through the speed controller (56) to provide a controlled amount of air into the interior of a shirt (54) and to allow the air to aid and to improve the natural cooling process of the user (100) by providing the additional airflow across the surface of the skin of the user.

11. The Special Personal Cooling device in claim 10 further comprised with leg ducts (130).

12. The Special Personal Cooling device in claim 10 wherein durable and resilient material of the belt is selected from a group consisting of natural leather, synthetic leather, cotton webbing, nylon, polyester, and composite materials.

13. The Special Personal Cooling device (30) in claim 10 wherein the durable and resilient material of the plenum, fan containers, and battery containers is selected from a group consisting of poly vinyl chloride (pvc), acryloitrile butadiene styrene (ABS), polyester, nylon, reinforced nylon, aluminum, steel and composite materials.

14. The Special Personal Cooling device in claim 10 wherein the durable and resilient material of the fan is selected from a group that can handle expected centrifugal forces, the group consisting of poly vinyl chloride (pvc), acrylonitrile butadiene styrene (ABS), polyester, nylon, reinforced nylon, aluminum, steel and composite materials.

15. The Special Personal Cooling device (30) in claim 10 wherein the battery type is selected from a group consisting of 12-volt, 6 volt, and 18 volt.

16. The Special Personal Cooling device (30) in claim 10 wherein the battery type is selected from a group consisting of a rechargeable type and a standard replaceable type.

17. The Special Personal Cooling device (30) in claim 10 wherein the battery material type is selected from a group consisting of Alkaline battery, Lead-acid battery, Lithium-ion battery, Nickel-cadmium battery, and Zinc chloride battery.

18. The Special Personal Cooling device (30) in claim 10 wherein the means to mechanically and integrally secure is selected from a group consisting of small threaded fasteners, clips, pop rivets, and plastic rods and spin over heads.

19. The Special Personal Cooling device (30) in claim 10 wherein the an electrical control system for controlling the power from the battery (46) to the motor (70) and the fan (44) through a shaft (68) is comprised of a set of wiring and typical wire connectors (59), a speed controller (56), a power plug-in (58), and a kill switch (48).

20. A Special Personal Cooling device (30) made of resilient and durable materials and comprised of:
(a) a belt system including a belt (60), clip receiver (50) and belt clip (52);
(b) a power system including a pair of a battery containers (47), a 12 V rechargeable battery (46), and container cover (47A);
(c) a fan system including a fan base (66), a fan drive shaft (68) and electric motor (70), a fan (44), a fan cover (64), and a finger guard (45);
(d) a means to mechanically secure the fan system, power system and belt system;
(f) an electrical control system for controlling the power from the battery (46) to the motor (70) and the fan (44) through a shaft (68) comprised of a set of wiring and typical wire connectors (59), a speed controller (56), a power plug-in (58), and a kill switch (48); and
(g) a set of leg ducts (130)
wherein the Special Personal Cooling device can be secured onto a torso of a user (100), secured to the shirt (54) of the user (100), and turned on through the speed controller (56) to provide a controlled amount of air into the interior of a shirt (54) and to allow the air to aid and to improve the natural cooling process of the user (100) by providing the additional airflow across the surface of the skin of the user.
